(19) United States
(12) Patent Application Publication
(10) Pub. No.: US 2026/0149176 A1
(43) Pub. Date: May 28, 2026

(54) MULTIBAND ARRAY ANTENNA AND MULTILAYER PHASE SHIFTER

(71) Applicant: Telefonaktiebolaget LM Ericsson (publ), Stockholm (SE)

(72) Inventors: Manfred Stolle, Bad Aibling (DE); Andre Schmidt, Rosenheim (DE); Jörg Langenberg, Rosenheim (DE); Jens Nita, Rosenheim (DE)

(21) Appl. No.: 19/123,904

(22) PCT Filed: Nov. 28, 2022
(86) PCT No.: PCT/EP2022/083437

§ 371 Date: Apr. 24, 2025

(51) Int. Cl. H01Q 5/30; H01Q 3/36

(52) U.S. Cl. CPC H01Q 5/30; H01Q 3/36

(57) ABSTRACT

A multiband array antenna for operation in multiple frequency bands. The multiband array antenna comprises a plurality of radiators for emitting electromagnetic waves in the multiple frequency bands. The multiband array antenna further comprises a distribution network coupled to the plurality of radiators for providing an electrical signal to the plurality of radiators. The multiband array antenna further comprises a phase shifter coupled to the plurality of radiators for changing a phase of the electrical signal provided to one or more of the plurality of radiators. The phase shifter is configured to operate in the multiple frequency bands. One or both of the distribution network and the phase shifter are configured to adjust an antenna tilt of the multiband array antenna differently for different frequency bands of the multiple frequency bands.

### TECHNICAL FIELD

The present disclosure generally relates to a multiband array antenna and a multilayer phase shifter for integrating a frequency-dependent electrical tilt behavior in an antenna array.

### BACKGROUND

The vertical Half Power Beam Width (HPBW) within an antenna array physically decreases due to the static system spacing and the free-space attenuation increases as the frequency of electromagnetic signals emitted by the antenna array increases. As a result, it is not possible to guarantee constant propagation characteristics and, consequently, a constant network coverage for broadband antenna systems.

Base station antennas use an adjustable electrical tilt, whereby the tilt can be adjusted individually for every frequency band, due to different transmit power, wave propagation and coverage requirements. For such solutions passive phase shifters are often used, as disclosed, for example, in U.S. Pat. No. 6,850,130 B1. The problem for adjusting broadband antennas to the network requirements was addressed by KR 10-2005-0071969 A, however, no optimal solution for the phase adjustment in the antenna array could be offered. The proposed impedance phase shifting device has to be located in every feeding line to the antennas, and is realized by a microstrip stub, generating a frequency dependent phase. No adjustable tilt is described.

In U.S. Pat. No. 9,899,747 B2, a coverage beam and a small beam are described, realized on two different inputs. No broadband approach for multiple bands is disclosed.

### SUMMARY

The inventors have realized that, with increasing integration of more frequency bands in one radio (e.g., B1, B3, B7), customers ask for a solution to realize independent band-individual down-tilt scenarios with passive macro antennas to optimize network performance. This is an established Way of Working, but would lead to more complex and expensive products. The problem is that the vertical beam-width of the antennas becomes narrower as the frequency increases. If the elevation beam is narrower and cannot cover all of the user elevation distribution, performance is sensitive to tilt. Comparing to band individual remote electrical tilt, common remote electrical tilt may set back the network performance. Therefore, a remote electrical tilt implementation is required, which gives a frequency dependent behavior.

According to a first aspect, there is provided a multiband array antenna for operation in multiple frequency bands. The antenna comprises a plurality of radiators for emitting electromagnetic waves in the multiple frequency bands. The antenna further comprises a distribution network coupled to the plurality of radiators for providing an electrical signal to the plurality of radiators. The antenna further comprises a phase shifter coupled to the plurality of radiators for changing a phase of the electrical signal provided to one or more of the plurality of radiators. The phase shifter is configured to operate in the multiple frequency bands. One or both of the distribution network and the phase shifter are configured to adjust an antenna tilt of the antenna differently for different frequency bands of the multiple frequency bands.

It is to be noted that “multiband” may hereby refer to two or more frequency bands, in particular two or more 3GPP frequency bands.

In some examples, the distribution network comprises a plurality of electrical cables coupling the plurality of radiators to the phase shifter. The distribution network comprises at least a first subset of the plurality of electrical cables to couple one or more outer radiators of the multiband array antenna and a second subset of the plurality of electrical cables to couple one or more central radiators of the multiband array antenna to the phase shifter. The one or more outer radiators are arranged radially more outwards relative to a center of the multiband array antenna compared to the one or more central radiators. An electrical cable of the second subset has an electrical length which differs by ±n×λ/2 from an electrical length of an electrical cable of the first subset, where n is an integer number between (and including) 1 and 4, and λ is a wavelength of an electromagnetic wave emittable by the multiband array antenna.

In some examples, a first subset of the plurality of radiators is rotated, in relation to a radiation direction, with respect to a second subset of the plurality of radiators. The distribution network is configured to adjust the antenna tilt differently for the different frequency bands by compensating a phase shift caused by the rotation based on an additional or reduced (electrical) length of a transmission line for the first subset of the plurality of radiators compared to the second subset of the plurality of radiators. The first subset may comprise one or more radiators and/or the second subset may comprise one or more radiators.

In some examples, the first subset of the plurality of radiators is rotated, in relation to the radiation direction, with respect to the second subset of the plurality of radiators by 180 degrees. In some other examples, the first subset of the plurality of radiators is not rotated, in relation to the radiation direction, with respect to the second subset of the plurality of radiators, but the difference in electrical length of cables coupled to the first subset of the plurality of radiators compared to the electrical length of cables coupled to the second subset of the plurality of radiators is one wavelength of the electromagnetic wave emittable by the radiators. When a rotation of the first subset of the plurality of radiators with respect to the second subset of the plurality of radiators of 180 degrees is implemented, in some examples, the difference in electrical length of cables coupled to the first subset of the plurality of radiators compared to the electrical length of cables coupled to the second subset of the plurality of radiators is half the wavelength (λ) of the electromagnetic wave emittable by the radiators. The rotation may be required if n is an odd integer and may not be required if n is an even integer, whereby the above-referenced difference in electrical lengths is n times λ/2.

In some examples, the distribution network is configured to change an electrical length for a varying number of transmission lines coupled to radiators in the first subset of the plurality of radiators.

In some examples, the phase shifter is a linear phase shifter.

In some examples, the phase shifter is a non-linear phase shifter for adjusting the antenna tilt of the antenna differently for the different frequency bands based on changing the phase of the electrical signal differently for different frequencies.

In some examples, the non-linear phase shifter comprises a plurality of electrically conductive concentric arcs, wherein each one of the plurality of concentric arcs is coupled to one or more corresponding, respective outputs of the phase shifter. The non-linear phase shifter further comprises an electrically conductive pivotable member. The plurality of concentric arcs is arranged in a first layer, the pivotable member is arranged in a second layer parallel to the first layer, wherein the pivotable member is configured to pivot within the second layer around a pivoting axis perpendicular to the second layer. The first layer and the second layer are spaced apart from each other via a third layer. The electrically conductive concentric arcs are electrically insulated from the electrically conductive pivotable member.

In some examples, the plurality of electrically conductive concentric arcs is comprised in a first printed circuit board, PCB.

In some examples, the electrically conductive pivotable member comprises a second PCB.

In some examples, each one of the plurality of concentric arcs comprises a corresponding, respective meander shape.

In some examples, the pivotable member comprises a plurality of coupling structures, wherein each one of the plurality of coupling structures aligns, in a direction perpendicular to the first layer and the second layer, with a corresponding, respective one of the plurality of concentric arcs.

In some examples, the coupling structures are coupled to each other via an impedance matching structure.

In some examples, the phase shifter further comprises a coupling layer arranged, on a side of the first layer which faces away from the second layer, between the first layer and a ground layer of the phase shifter.

In some examples, the coupling layer aligns, in a direction perpendicular to the first layer, with one or more of the plurality of concentric arcs.

In some examples, the multiband array antenna further comprises one or more transmission lines each comprising a plurality of stubs. One or more of a length of the stubs, a width of the stubs and a gap between stubs varies for at least some of the stubs. Additionally or alternatively, the one or more transmission lines each comprises one or more defected ground structures.

In some examples, the meander shape comprises varying widths and/or varying gaps between elements of the meander shape.

In some examples, the pivotable member is configured to pivot within the second layer around the pivoting axis over a range of no more than 50% of an area covering, in a direction perpendicular to the second layer, the plurality of concentric arcs.

In some examples, the frequency-dependent electrical tilt may in particular be implemented via a multilayer phase shifter according to some examples as outlined throughout the present disclosure.

According to a second aspect, there is therefore provided a multilayer phase shifter for shifting a phase of a signal provided to a radiator of an antenna. The multilayer phase shifter comprises a plurality of electrically conductive concentric arcs. Each one of the plurality of concentric arcs is coupled to one or more corresponding, respective outputs of the multilayer phase shifter. The multilayer phase shifter further comprises an electrically conductive pivotable member. The plurality of concentric arcs is arranged in a first layer, the pivotable member is arranged in a second layer parallel to the first layer, wherein the pivotable member is configured to pivot within the second layer around a pivoting axis perpendicular to the second layer. The first layer and the second layer are spaced apart from each other via a third layer. The electrically conductive concentric arcs are electrically insulated from the electrically conductive pivotable member.

In some examples, the plurality of electrically conductive concentric arcs is comprised in a first printed circuit board, PCB.

In some examples, the electrically conductive pivotable member comprises a second PCB.

In some examples, each one of the plurality of concentric arcs comprises a corresponding, respective meander shape.

In some examples, the pivotable member comprises a plurality of coupling structures. Each one of the plurality of coupling structures aligns, in a direction perpendicular to the first layer and the second layer, with a corresponding, respective one of the plurality of concentric arcs. The coupling structures are electrically insulated from the plurality of concentric arcs.

In some examples, the coupling structures of the pivotable member are coupled to each other via an impedance matching structure.

In some examples, the phase shifter further comprises a coupling layer arranged, on a side of the first layer which faces away from the second layer, between the first layer and a ground layer of the phase shifter.

In some examples, the coupling layer aligns, in a direction perpendicular to the first layer, with one or more of the plurality of concentric arcs.

In some examples, the pivotable member is configured to pivot within the second layer around the pivoting axis over a range of no more than 50% of an area covering, in a direction perpendicular to the second layer, the plurality of concentric arcs.

The present disclosure outlines various solutions of multiband array antennas and multilayer phase shifters, respectively, to generate a phase deviation to produce a static or a dynamic electrical downtilt deviation between the frequency bands. By means of the described solutions, the tilt of the antenna can be adjusted according to the network requirements for different used frequency bands with individual implemented dependency of tilt from the operated frequency band, e.g. to prevent intercell interference at low tilts and keep the coverage at optimum for higher tilt values. For the different frequency bands, the sector structure in the network can be optimized for the different sites and antenna tilt values.

### BRIEF DESCRIPTION OF THE DRAWINGS

Further aspects, details and advantages of the present disclosure will become apparent from the detailed description of exemplary embodiments below and from the drawings, wherein:

FIG. 1 shows a schematic block diagram of a multiband array antenna according to some example implementations as described herein;

FIG. 2 shows tilt deviation for a lowest and highest frequency according to some examples as described herein;

FIG. 3 shows a comparison tilt over frequency of an antenna according to the state of the art versus the desired tilt behavior according to some example implementations as described herein;

FIGS. 4a to 4g show schematic illustrations of parts of a phase shifter according to some example implementations as described herein;

FIG. 5 shows a non-linear transmission phase of a multilayer meander transmission line according to some example implementations as described herein;

FIG. 6 shows a cross-sectional side view of a schematic illustration of a transmission line with stubs according to some example implementations as described herein;

FIG. 7 shows a top view of a schematic illustration of a transmission line with defected ground structures according to some example implementations as described herein;

FIG. 8 shows a top view of a schematic illustration of a meander transmission line with varying width and gaps according to some example implementations as described herein;

FIG. 9 shows a top view of a schematic illustration of parts of a phase shifter according to some example implementations as described herein;

FIGS. 10 and 11 show antenna tilt angle for different frequency bands according to some examples as described herein.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

The present disclosure generally relates to frequency-adjusted electrical tilt for a multiband array antenna. The solutions outlined herein for integrating a frequency-dependent electrical tilt behavior in an antenna array allow in particular to improve the network performance over the supported frequency bands. Example implementations outlined herein may be applied, for example, to optimize the Uplink and Downlink of an antenna array which supports, for example, band 1 (UL 1920-1980 MHz, DL 2110-2170 MHz), band 3 (UL 1710-1785 MHz, DL 1805-1880 MHz) and band 7 (UL 2500-2570 MHz, DL 2620-2690 MHz), although other bands may additionally or alternatively be supported.

The trend in base station antennas is towards arrays with ever increasing relative bandwidth. This offers the network operator the possibility to use several 3GPP bands via one array which can be controlled via the same Remote Electrical Tilt device, i.e. based on the AISG standard. The disadvantage of this wideband array is the physical effect that the vertical half-power beamwidth becomes narrower towards higher frequencies. With this effect it may not be possible to have the same network coverage for all supported frequencies in the same cell. In current antennas, network providers use different arrays for the lower band (e.g. Band 1 and Band 3) and the higher band (e.g. Band 7). Example implementations as outlined herein show the way to use a wideband radio in combination with an array to achieve the best network performance for each frequency band. In an additional step, it is possible to integrate a dynamic tilt offset in the tilt range. This improves the network coverage in particular for rural suburban and urban scenarios, which differ in the down tilt used.

### Tilt Behavior With Linear Phase Shifter

In a standard antenna array system, all radiators are normally orientated in the same direction. If a radiator is rotated by 180 degrees, a phase error is obtained which leads to an undesired pattern distortion. This effect can be compensated for by changing the electrical length in the distribution network. If the length is reduced or extended by λ/2 for a specific frequency, a phase error is obtained for the frequencies below or above this specific frequency point. If this behavior is used correctly, one can create a tilt desired deviation over the frequency band. With an increasing number of rotated elements, the absolute tilt offset can be adjusted.

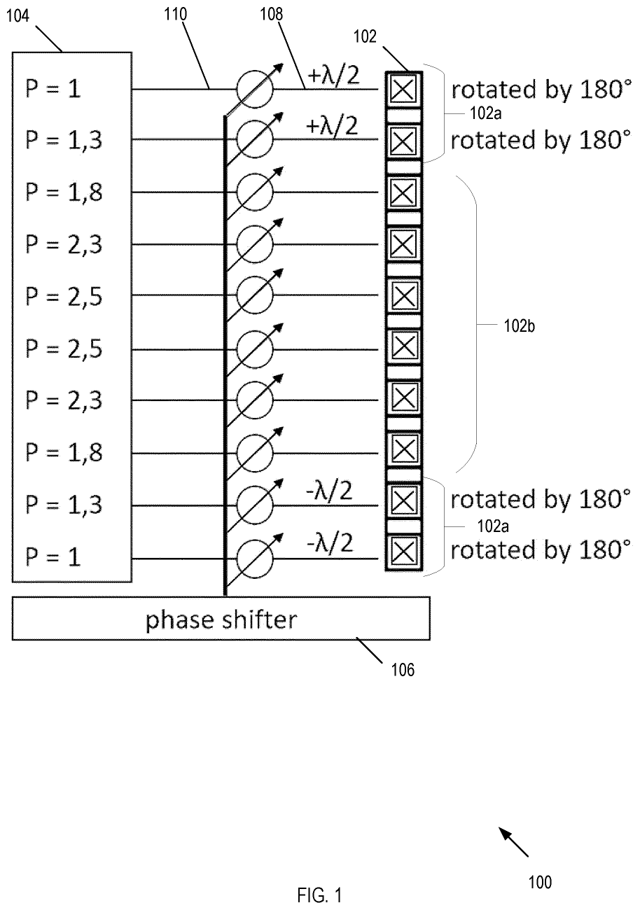

FIG. 1 shows a schematic block diagram of a multiband array antenna 100 according to some example implementations as described herein.

In FIG. 1, a schematic of an antenna array 100 with a plurality of radiators 102, a distribution network 104, and a linear phase shifter 106 is shown, with rotated radiators and phase compensation via the linear phase shifter 106 via an additional or a reduced line length of λ/2 in the outer lines (electrical cables 108), which results in a frequency-dependent tilt. The phase shifter 106 itself is linear. Electrical cables 108 are used to couple the radiators 102 to the phase shifter 106. Transmission lines 110 couple the distribution network 104 to the radiators 102. In this example, the power P of signals provided to the radiators 102 varies and is smaller for the outer radiators 102a (relative value of “1”) compared to the central radiators 102b (relative value of, e.g., “2.5”) in order to reduce the side lobe level.

In this example, the two outer radiators 102a on each side are rotated with respect to the central radiators 102b by 180 degrees and the lines (electrical cables 108) are typically λ/2 longer or λ/2 shorter in relation to the central lines to compensate the rotation.

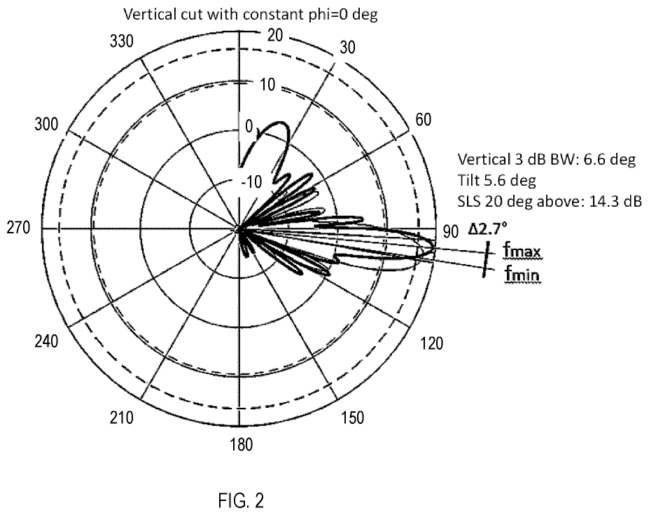

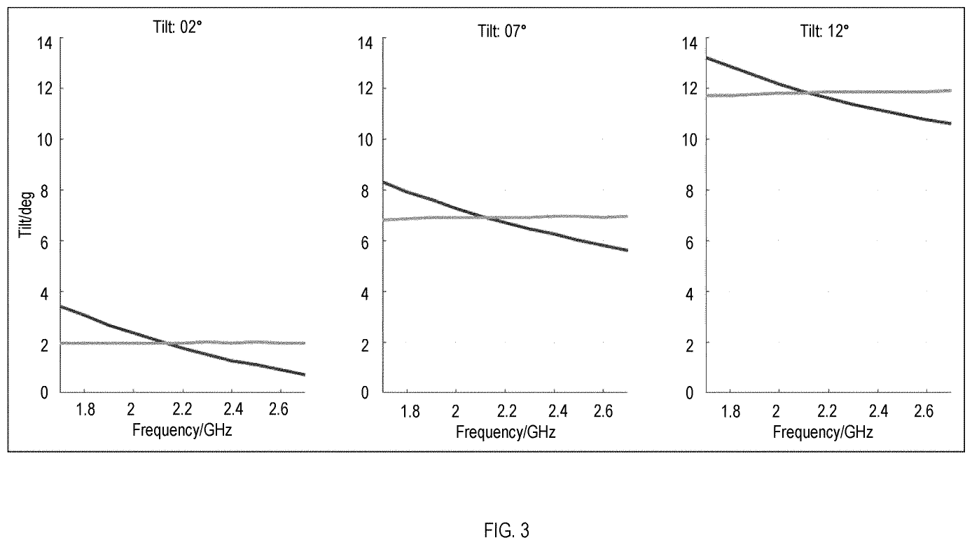

A static tilt offset of 2.7 degrees is created between 1.7 GHz and 2.7 GHz in a tilt range of 2 degrees to 12 degrees in a special position of the phase shifter device, as can be seen in FIGS. 2 and 3. FIG. 2 hereby shows the tilt deviation for a lowest and highest frequency, in this example for a constant coverage regarding an area to which electromagnetic waves are to be transmitted by the antenna. In FIG. 3, the horizontal line relates to the tilt behavior according to the state of the art, where no measurable or significant frequency dependency of the tilt is observed, whereas in example implementations as outlined herein, the tilt is strongly dependent on the frequency.

The slope of the frequency dependence according to FIG. 3 can be adjusted by selecting the number of rotated radiator groups in the outer region, i.e. if, for example, 1, 2 or 3 etc. radiators are rotated. The slope also depends on the number of added or removed half-wavelengths in the outer lines in combination with the rotation of the radiators.

### Tilt Behavior With a Non-Linear Phase Shifter

Another approach to realize a frequency-dependent behavior of the down tilt is an integration of this behavior directly in the phase shifter. This may, of course, be combined with the implementation outlined above regarding rotation of radiators and line length compensation.

A phase shifter may hereby use concentric arcs on a microstrip PCB design. A second PCB is used as a pivoting element. A space optimized solution of the concentric arcs uses a meander design. By intentionally designing the meander structure (such as length, spacing, outline, additional copper structures using multilayer PCB configuration) of each arc in the way that the necessary frequency behavior is achieved, it is possible to realize the frequency dependent down tilt.

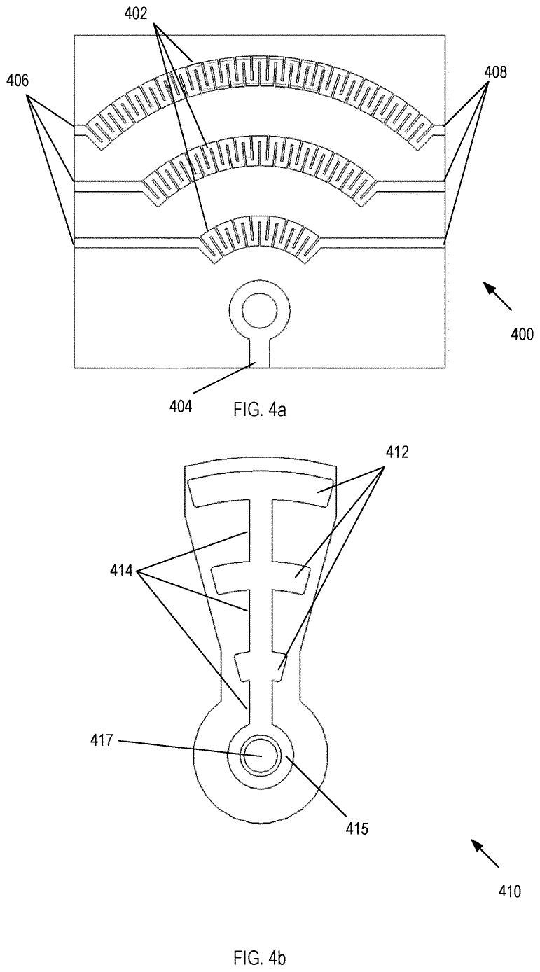

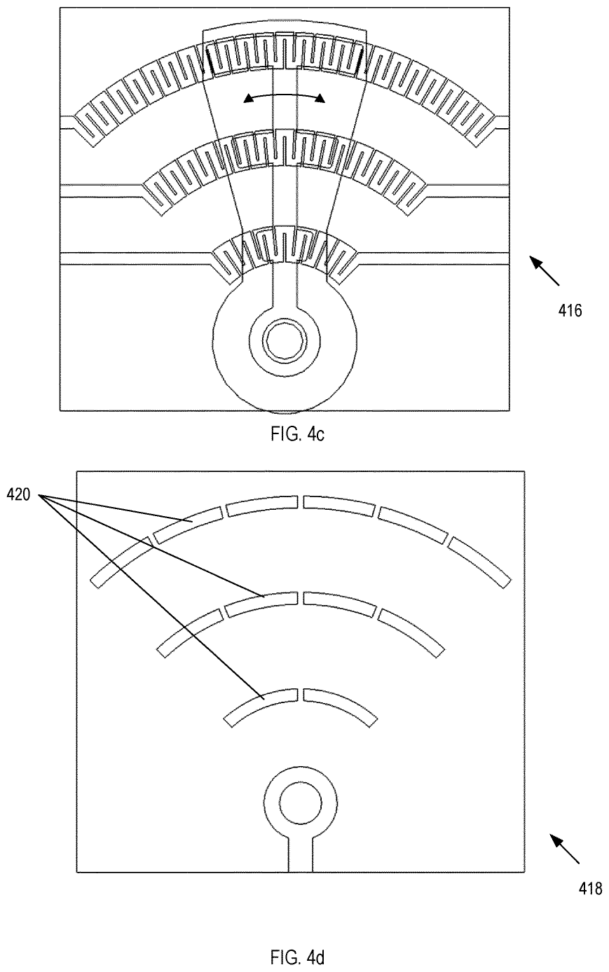

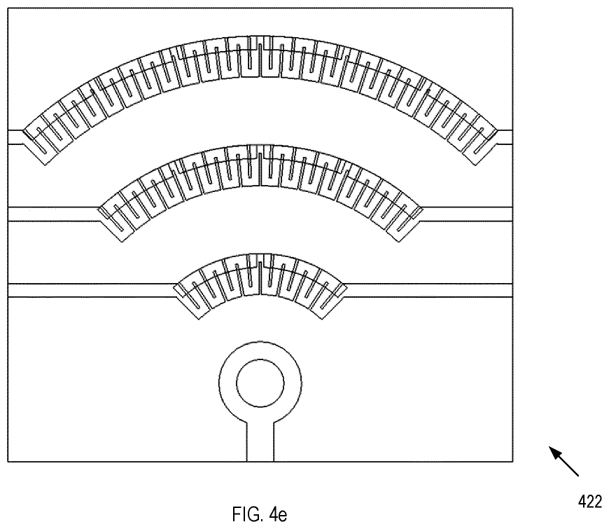

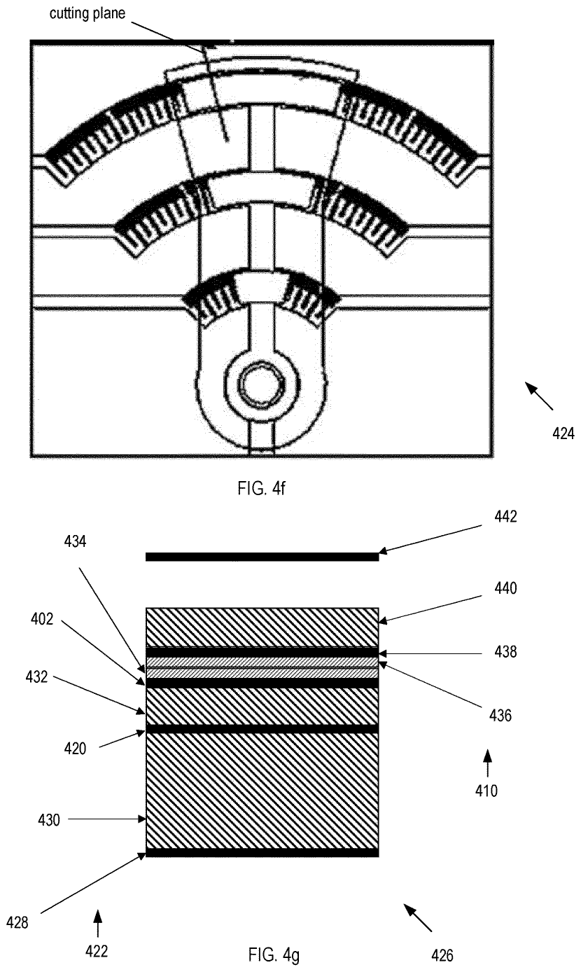

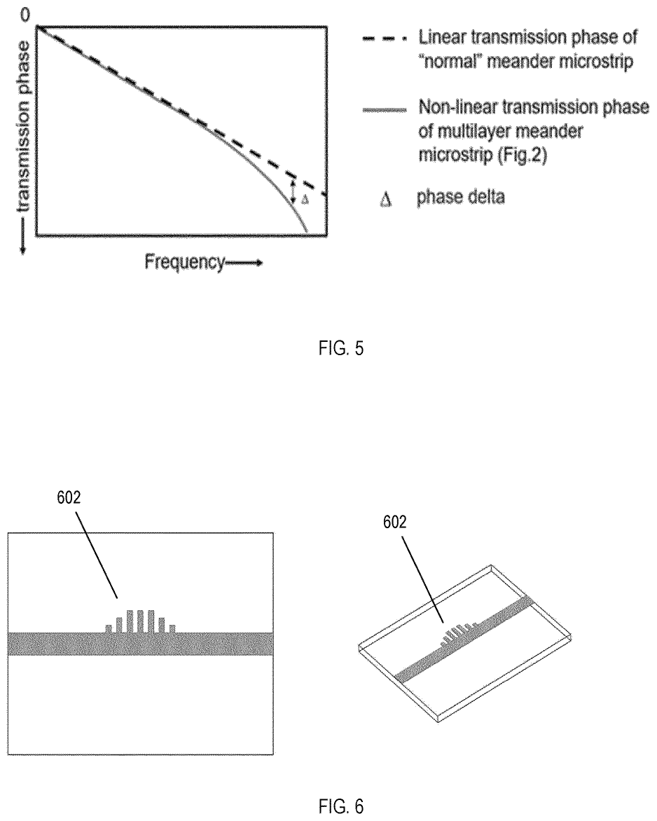

FIGS. 4a to 4g show schematic illustrations of parts of a phase shifter according to some example implementations as described herein.

FIG. 4a shows a top view of a schematic illustration of a microstrip PCB phase shifter 400. In this example, the phase shifter 400 comprises three electrically conductive concentric arcs 402, but it will be appreciated that another number of electrically conductive concentric arcs may be implemented.

The phase shifter 400 comprises an input 404 and a plurality of outputs 406, 408 which are connected to the electrically conductive concentric arcs 402.

FIG. 4b shows a top view of a schematic illustration of a PCB pivoting member 410/element. In this example, coupling structures 412 of the pivoting member 410 are coupled to the meander lines in the concentric arcs 402 and connect the coupled signal via an impedance matching structure 414 to the ring 415 at the rotation center 417, which is, in this example, coupled capacitively to the input 404 in FIG. 4a.

FIG. 4c shows a top view of a schematic illustration of a PCB 416 assembly. The pivoting angle for the pivoting member 410 is indicated.

By adding, for example, additional coupling structures in a multilayer phase shifter PCB, the impedance characteristics and especially the frequency dependence of the phase shift of the meander lines can be changed to obtain a non-linear phase characteristic. This is, in this example, (mainly) achieved by capacitively bridging the meander line parts via the arcs to the coupling layer in a strong frequency-dependent manner. The number of arcs and the length of the arcs as well as the distance to the meander lines can be optimized to adjust the frequency dependence of the phase shift of the resulting structure. For example, in the mid layer 418, an additional PCB coupling layer structure 420, for example in the form of concentric arcs, may be provided, as shown in FIG. 4d which depicts a top view of a schematic illustration of the mid layer 418 with the additional PCB coupling layer structure 420.

FIG. 4e shows a top view of a schematic illustration of a phase shifter multilayer PCB 422, in which the PCB substrate is shown transparent for illustrative purposes. As can be seen, the concentric arcs of the additional PCB coupling layer structure 420 aligns in the direction perpendicular to the layers with the electrically conductive concentric arcs 402 shown in FIG. 4a.

FIG. 4f shows a top view of a schematic illustration of the PCB assembly 424, in which the parts of the different layers are illustrated. FIG. 4g shows a PCB assembly cutting view 426 according to the cutting plane illustrated in FIG. 4f.

In this example, the PCB assembly 424 comprises the pivoting PCB (member 410) and the phase shifter PCB 422.

The PCB assembly 424 is hereby constructed via a ground layer 428 on which a first substrate 430 is arranged.

On top of the first substrate 430, the additional coupling layer 420 is provided, followed, on top thereof, by a second substrate 432.

In this example, a meander line (electrically conductive concentric arcs 402) is arranged on top of the second substrate, followed by a first solder resist 434.

On top of the first solder resist 434, a second solder resist 436 is arranged, followed by a pivoting layer 438 and a pivoting substrate 440.

Optionally, a cover 442 may be provided on top of the pivoting substrate 440.

One or both of the first solder resist 434 and the second solder resist 436 may be replaced by a dielectric coupling layer.

The first and the second substrate 430,432 may be mechanically fixed with low tolerances to achieve a stable impedance and coupling behavior. Typically, they can be pressed to each other and form a multilayer PCB.

By adding, for example, additional coupling structures in the multilayer phase shifter PCB, the impedance and phase shift characteristics of the meander lines can be changed to obtain a non-linear phase characteristic, as can be seen in the non-linear transmission phase of a multilayer meander transmission line (solid line) depicted in FIG. 5, which is different to a linear characteristic of a typical TEM microstrip line (dashed line in FIG. 5).

The additional coupling structure in a multilayer phase shifter PCB as depicted in FIGS. 4d to 4g are, in this example, located between the ground and the top copper layer of the multilayer PCB. The additional PCB coupling layer structure shown in FIG. 4d is, in this example, in the mid layer, which is electrically isolated from the other layers of the phase shifter.

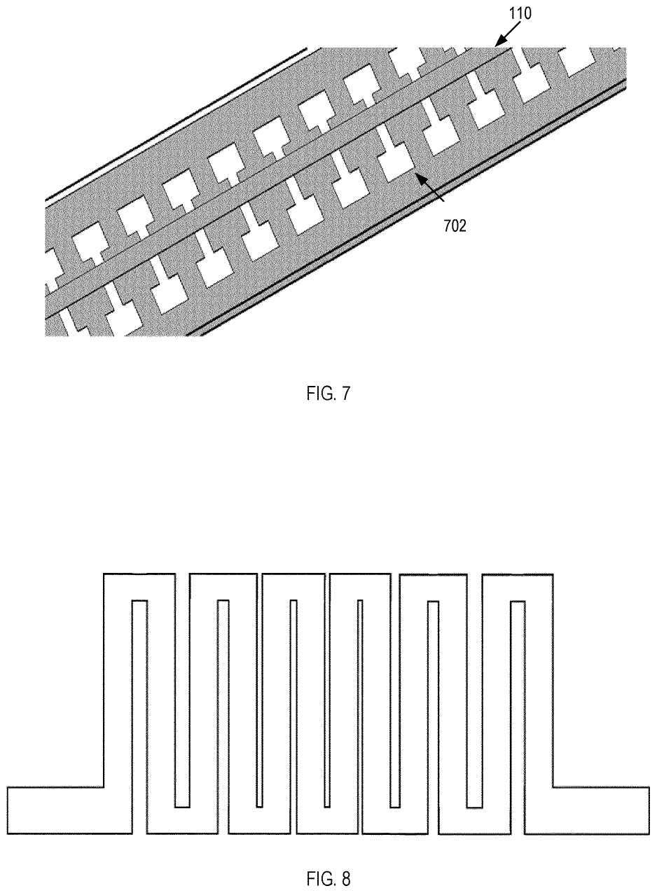

Another example to create a non-linear transmission phase is, for example, based on transmission lines with additional stubs 602 of different length, width and gaps in between them, as can be seen in FIG. 6 which shows a cross-sectional side view of a schematic illustration of a transmission line with stubs 602 according to some example implementations as described herein. This concept may be combined with any one or more of the above-described implementations (in particular the concept depicted in FIG. 1 and/or the concept depicted in FIGS. 4a to 4g) to create a non-linear transmission phase.

A further example to create a non-linear transmission phase is, for example, based on transmission lines with defected ground structures 702, as shown in FIG. 7 which depicts a top view of a schematic illustration of a transmission line with defected ground structures 702 according to some example implementations as described herein. This concept may be combined with any one or more of the above-described implementations (in particular the concept depicted in FIG. 1 and/or the concept depicted in FIGS. 4a to 4g and/or FIG. 6) to create a non-linear transmission phase.

A further example to create a non-linear transmission phase is, for example, based on meander transmission lines with different width and gaps, as shown in FIG. 8 which depicts a top view of a schematic illustration of a meander transmission line with varying width and gaps according to some example implementations as described herein. This concept may be combined with any one or more of the above-described implementations (in particular the concept depicted in FIG. 1 and/or the concept depicted in FIGS. 4a to 4g and/or FIG. 6 and/or FIG. 7) to create a non-linear transmission phase.

All combinations of multilayer structures including, in particular, additional stubs, defected ground structures and different meander line width and gaps are possible solutions. So the meander arcs with the coupling layer in FIG. 4f can be substituted, for example, by line structures according to FIG. 6 and FIG. 7. Another approach is the combination of a normal linear phase shifter and the line structures according to FIG. 6 and FIG. 7 between the outputs from the phase shifter to the radiators to produce the nonlinear phase behavior at the different radiators.

In order to obtain optimal antenna performance with a frequency-dependent behavior of the down-tilt, in some examples, for every arc of the phase shifter, the non-linear phase behavior has the same ratio as the arcs of a normal phase shifter for the same antenna concept.

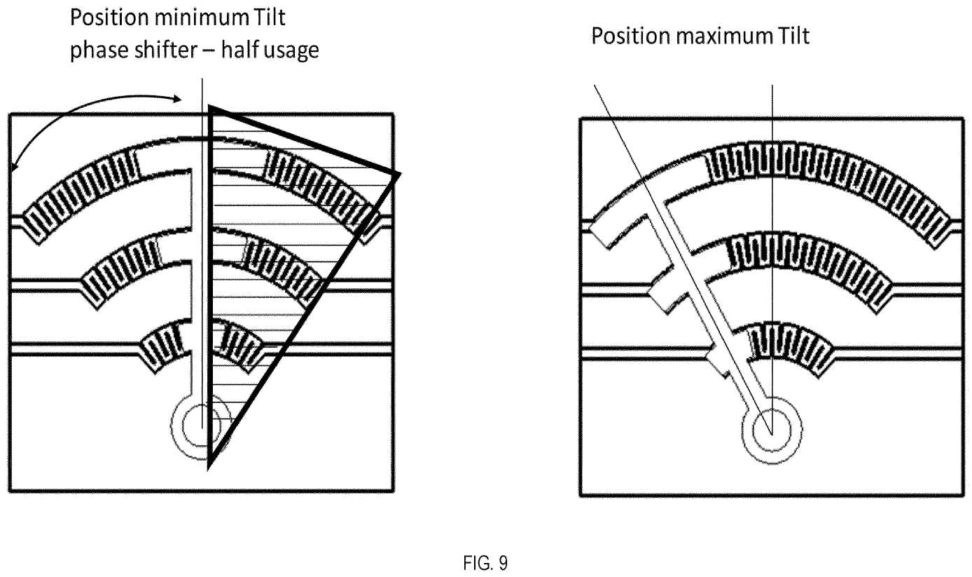

FIG. 9 shows a top view of a schematic illustration of parts of a phase shifter according to some example implementations as described herein.

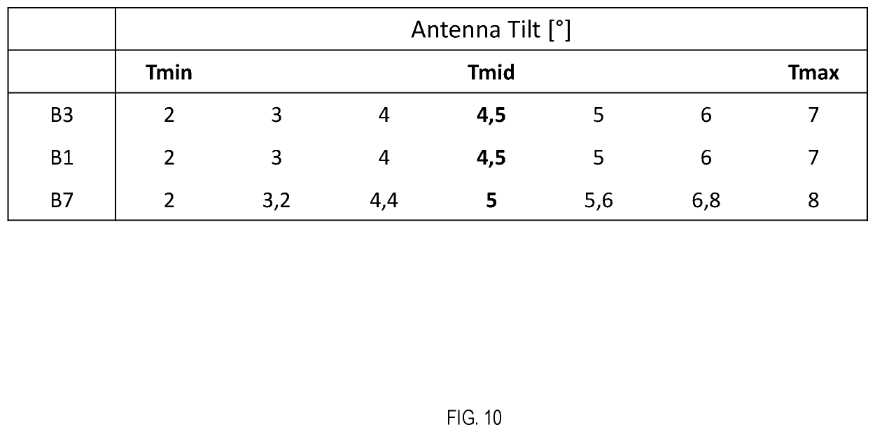

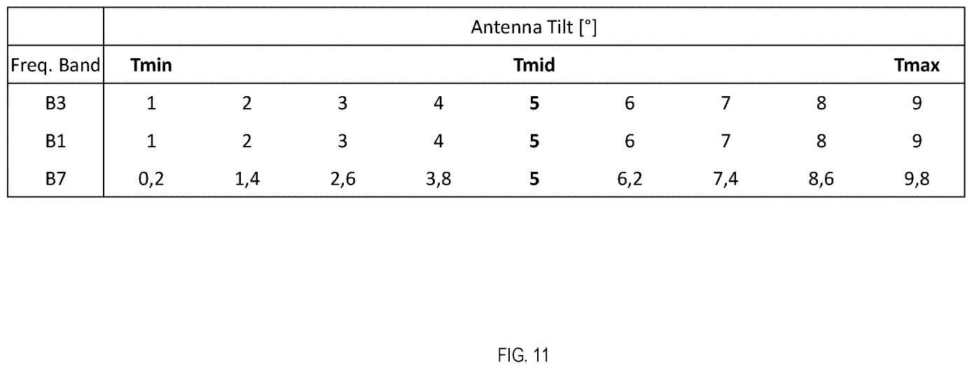

Using only the half pivoting angle of the phase shifter (see FIG. 9), it is possible to get an equal antenna minimum tilt for all frequencies, but different antenna tilts over frequency at maximum tilt position, as shown in the table of FIG. 10. Otherwise, the antenna tilt is equal for all frequencies at Tmid and different at the minimum tilt Tmin and maximum tilt Tmax (see example tilt values of the table of FIG. 11).

Any one or more examples outlined throughout the present disclosure may be implemented in link budget considerations in which the link budget is frequency-dependent. The link budget may hereby account for all power gains and losses which a communication signal experiences in a telecommunication system in which the antenna is implemented. The examples outlined herein may be used in a constant coverage service and in an interleaved cell approach.

In the constant coverage service, the gain of an antenna array increases with frequency (but may be limited by a minimum halfpower beamwidth). For a broadband antenna array for a fixed sector (using the same radiators), the gain can be considered increasing linearly with frequency (assuming one dimensional halfpower beamwidth/vertical decrease, horizontal constant sectorized approach). The gain of the user equipment can be considered, in some examples, to not increase proportionally to frequency, but may be considered as constant. Therefore, the path loss may be expected higher for higher frequencies (approximately proportional to f . . . f²). This would require less tilt for higher frequencies (which may be the goal for identical coverage).

In the interleaved cell approach, small cell coverage may be kept for high frequencies, and a fill raster with additional high band sites may be considered. A higher tilt for high(er) frequencies may be implemented to adjust the cell structure. In other words, the tilt down may be implemented also for high(er) frequencies.

It will be appreciated that the present disclosure has been described with reference to exemplary embodiments that may be varied in many aspects. As such, the present invention is only limited by the claims that follow.

1. A multiband array antenna for operation in multiple frequency bands, wherein the multiband array antenna comprises:
a plurality of radiators for emitting electromagnetic waves in the multiple frequency bands;
a distribution network coupled to the plurality of radiators for providing an electrical signal to the plurality of radiators; and
a phase shifter coupled to the plurality of radiators for changing a phase of the electrical signal provided to one or more of the plurality of radiators, wherein the phase shifter is configured to operate in the multiple frequency bands;
wherein one or both of the distribution network and the phase shifter are configured to adjust an antenna tilt of the multiband array antenna differently for different frequency bands of the multiple frequency bands.

2. The multiband array antenna of claim 1, wherein the distribution network comprises a plurality of electrical cables coupling the plurality of radiators to the phase shifter, wherein the distribution network comprises at least a first subset of the plurality of electrical cables to couple one or more outer radiators of the multiband array antenna and a second subset of the plurality of electrical cables to couple one or more central radiators of the multiband array antenna to the phase shifter, wherein the one or more outer radiators are arranged radially more outwards relative to a center of the multiband array antenna compared to the one or more central radiators, wherein an electrical cable of the second subset has an electrical length which differs by ±n×λ/2 from an electrical length of an electrical cable of the first subset, where n is an integer number between 1 and 4, and λ is a wavelength of an electromagnetic wave emittable by the multiband array antenna.

3. The multiband array antenna of claim 1, wherein a first subset of the plurality of radiators is rotated, in relation to a radiation direction, with respect to a second subset of the plurality of radiators, and wherein the distribution network is configured to adjust the antenna tilt differently for the different frequency bands by compensating a phase shift caused by the rotation based on an additional or reduced length of a transmission line for the first subset of the plurality of radiators compared to the second subset of the plurality of radiators; and
wherein the first subset of the plurality of radiators is rotated, in relation to the radiation direction, with respect to the second subset of the plurality of radiators by 180 degrees.

4. (canceled)

5. The multiband array antenna of claim 2, wherein the distribution network is configured to change an electrical length for a varying number of transmission lines coupled to radiators in the first subset of the plurality of radiators.

6. The multiband array antenna of claim 1, wherein the phase shifter is a linear phase shifter.

7. The multiband array antenna of claim 1, wherein the phase shifter is a non-linear phase shifter for adjusting the antenna tilt of the multiband array antenna differently for the different frequency bands based on changing the phase of the electrical signal differently for different frequencies.

8. The multiband array antenna of claim 7, wherein the non-linear phase shifter comprises:
a plurality of electrically conductive concentric arcs, wherein each one of the plurality of concentric arcs is coupled to one or more corresponding, respective outputs of the phase shifter; and
an electrically conductive pivotable member;
wherein the plurality of concentric arcs is arranged in a first layer, the pivotable member is arranged in a second layer parallel to the first layer, wherein the electrically conductive pivotable member is configured to pivot within the second layer around a pivoting axis perpendicular to the second layer, and wherein the first layer and the second layer are spaced apart from each other via a third layer, wherein the electrically conductive concentric arcs are electrically insulated from the electrically conductive pivotable member.

9. The multiband array antenna of claim 8, wherein the plurality of electrically conductive concentric arcs is comprised in a first printed circuit board (PCB); and
wherein the electrically conductive pivotable member comprises a second PCB.

10. (canceled)

11. The multiband array antenna of claim 8, wherein each one of the plurality of electrically conductive concentric arcs comprises a corresponding, respective meander shape.

12. The multiband array antenna of claim 8, wherein the electrically conductive pivotable member comprises a plurality of coupling structures, and wherein each one of the plurality of coupling structures aligns, in a direction perpendicular to the first layer and the second layer, with a corresponding, respective one of the plurality of electrically conductive concentric arcs.

13. The multiband array antenna of claim 12, wherein the coupling structures are coupled to each other via an impedance matching structure.

14. The multiband array antenna of claim 8, wherein the phase shifter further comprises a coupling layer arranged, on a side of the first layer which faces away from the second layer, between the first layer and a ground layer of the phase shifter; and
wherein the coupling layer aligns, in a direction perpendicular to the first layer, with one or more of the plurality of concentric arcs.

15. (canceled)

16. The multiband array antenna of claim 1, comprising one or more transmission lines each comprising a plurality of stubs, wherein at least one of (i) one or more of a length of the stubs, a width of the stubs and a gap between the stubs varies for at least some of the stubs, and (ii) wherein the one or more transmission lines each comprises one or more defected ground structures.

17. The multiband array antenna of claim 11, wherein the meander shape comprises at least one of varying widths and varying gaps between elements of the meander shape.

18. The multiband array antenna of claim 8, wherein the electrically conductive pivotable member is configured to pivot within the second layer around the pivoting axis over a range of no more than 50% of an area covering, in a direction perpendicular to the second layer, the plurality of electrically conductive concentric arcs.

19. A multilayer phase shifter for shifting a phase of a signal provided to a radiator of an antenna, wherein the multilayer phase shifter comprises:
a plurality of electrically conductive concentric arcs, wherein each one of the plurality of electrically conductive concentric arcs is coupled to one or more corresponding, respective outputs of the multilayer phase shifter; and
an electrically conductive pivotable member;
wherein the plurality of electrically conductive concentric arcs is arranged in a first layer, the electrically conductive pivotable member is arranged in a second layer parallel to the first layer, wherein the electrically conductive pivotable member is configured to pivot within the second layer around a pivoting axis perpendicular to the second layer, and wherein the first layer and the second layer are spaced apart from each other via a third layer, wherein the electrically conductive concentric arcs are electrically insulated from the electrically conductive pivotable member.

20. The multilayer phase shifter of claim 19, wherein the plurality of electrically conductive concentric arcs is comprised in a first printed circuit board (PCB);
wherein the electrically conductive pivotable member comprises a second PCB;
wherein each one of the plurality of electrically conductive concentric arcs comprises a corresponding, respective meander shape;
wherein the electrically conductive pivotable member comprises a plurality of coupling structures, and wherein each one of the plurality of coupling structures aligns, in a direction perpendicular to the first laver and the second layer, with a corresponding, respective one of the plurality of electrically conductive concentric arcs, wherein the coupling structures are electrically insulated from the plurality of concentric arcs; and
wherein the coupling structures of the electrically conductive pivotable member are coupled to each other via an impedance matching structure.

21.-24. (canceled)

25. The multilayer phase shifter of claim 19, wherein the phase shifter further comprises a coupling layer arranged, on a side of the first layer which faces away from the second layer, between the first layer and a ground layer of the phase shifter.

26. The multilayer phase shifter of claim 25, wherein the coupling layer aligns, in a direction perpendicular to the first layer, with one or more of the plurality of electrically conductive concentric arcs.

27. The multilayer phase shifter of claim 19, wherein the electrically conductive pivotable member is configured to pivot within the second layer around the pivoting axis over a range of no more than 50% of an area covering, in a direction perpendicular to the second layer, the plurality of electrically conductive concentric arcs.
